(19) United States
(12) Patent Application Publication
(10) Pub. No.: US 2026/0357980 A1
(43) Pub. Date: Nov. 12, 2026

(54) SYSTEMS AND METHODS EMPLOYING OXY-FUEL COMBUSTION AND CARBON DIOXIDE RECUPERATION

(71) Applicant: Schlumberger Technology Corporation, Sugar Land, TX (US)

(72) Inventors: Roman Alexandrovich Skachkov, Cambridge, MA (US); Kirill Leonidovich Klimenok, Cambridge, MA (US); Sharath Chandra Mahavadi, Cambridge, MA (US); Vitaly Senich, Mussafah (AE)

(21) Appl. No.: 19/660,517

(22) Filed: Apr. 28, 2026

Related U.S. Application Data
(60) Provisional application No. 63/802,139, filed on May 8, 2025.

(51) Int. Cl. F23J 15/02; C01B 17/04; C01B 17/79; C01B 17/80; C01B 32/50; F25J 1/00

(52) U.S. Cl. CPC F23J 15/02; C01B 17/0478; C01B 17/79; C01B 17/806; C01B 32/50; F25J 1/0015; F25J 1/0027; C01B 2210/0046; C01B 2210/0071

(57) ABSTRACT

Systems and methods are provided that employ an oxy-fuel combustor configured to combust a mixture of raw hydrocarbon gas, an oxygen-rich gas substantially free of nitrogen and carbon dioxide gas. The combustion byproduct is continuously processed to extract carbon dioxide gas from the combustion byproduct and return at least a portion of extracted carbon dioxide gas to the oxy-fuel combustor for part of the mixture combusted therein. The combustion byproduct processing loop can be configured to perform additional continuous processing of the combustion byproduct, such as liquefication of carbon dioxide, extraction of sulfur dioxide and conversion of sulfur dioxide to sulfuric acid or solid sulfur, and extraction of water and water purification. The oxy-fuel combustor can be embodied by an enclosed reactor. The components of the system can have a modular architecture that allows for at least one of transportation, customization, and scaling through the addition of standardized units.

### CROSS REFERENCE TO RELATED APPLICATIONS

This application claims priority to U.S. Provisional Patent Application No. 63/802,139, which was filed on May 8, 2025, and is incorporated herein by reference in its entirety.

### FIELD

The present disclosure relates to systems and methods that employ oxy-fuel combustion.

### BACKGROUND

This section provides background information to facilitate a better understanding of the various aspects of the present disclosure. It should be understood that the statements in this section of this document are to be read in this light, and not as admissions of prior art.

Oxy-fuel combustion burns fuel (typically natural gas or coal) in nearly pure oxygen instead of air, thus eliminating nitrogen oxide (NOₓ) components as a byproduct of the combustion process.

Oxy-fuel combustion can release significant amounts of carbon dioxide into the atmosphere during fuel combustion, contributing to climate change. Furthermore, the conventional oxy-fuel combustion has other significant limitations, including:
production of harmful pollutants, including sulfur-based components, which are typically released into the atmosphere;
wastes substantial heat;
cannot process raw natural gas supply streams containing hydrogen sulfide (H₂S); instead, contaminants (such as hydrogen sulfide and water) are removed from the natural gas supply stream that is input to the oxy-fuel combustor;
performed by permanent infrastructure at a fixed location, and such permanent infrastructure requires extensive on-site construction with complex installation requirements; and
control systems that monitor and control the oxy-fuel combustion are powered by electricity generated from external sources.

### SUMMARY

According to one or more aspects of the disclosure, systems and methods are provided that employ oxy-fuel combustion. An oxy-fuel combustor is configured to combust a mixture of raw hydrocarbon gas, an oxygen-rich gas and carbon dioxide gas, wherein the oxygen-rich gas is substantially free of nitrogen. A combustion byproduct processing loop is configured to continuously process the combustion byproduct of the oxy-fuel combustor to extract carbon dioxide gas from the combustion byproduct and return at least a portion of extracted carbon dioxide gas to the oxy-fuel combustor for part of the mixture combusted therein.

In embodiments, the combustion byproduct processing loop can be configured to perform additional continuous processing of the combustion byproduct, such as liquefaction of carbon dioxide, extraction of sulfur dioxide and conversion of sulfur dioxide to sulfuric acid, extraction of heat, and extraction of water and water purification.

In embodiments, the oxy-fuel combustor can be embodied by an enclosed reactor.

In embodiments, the components of the system can have a modular architecture that allows for at least one of transportation, customization, and scaling through the addition of standardized units.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings as described below.

FIG. 1 is a schematic diagram of an example embodiment of an oxy-fuel combustion system in accordance with the present disclosure.

FIG. 2 is a schematic diagram of another example embodiment of an oxy-fuel combustion system in accordance with the present disclosure.

FIG. 3 is an energy balance diagram of an example embodiment of an oxy-fuel combustion system similar to the systems of FIGS. 1 and 2.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and will not in itself dictate a relationship between the various embodiments and/or configurations discussed.

As used herein, the terms connect, connection, connected, in connection with, and connecting may be used to mean in direct connection with or in connection with via one or more elements. Similarly, the terms couple, coupling, coupled, coupled together, and coupled with may be used to mean directly coupled together or coupled together via one or more elements. Terms such as up, down, top and bottom and other like terms indicating relative positions to a given point or element may be utilized to describe some elements more clearly.

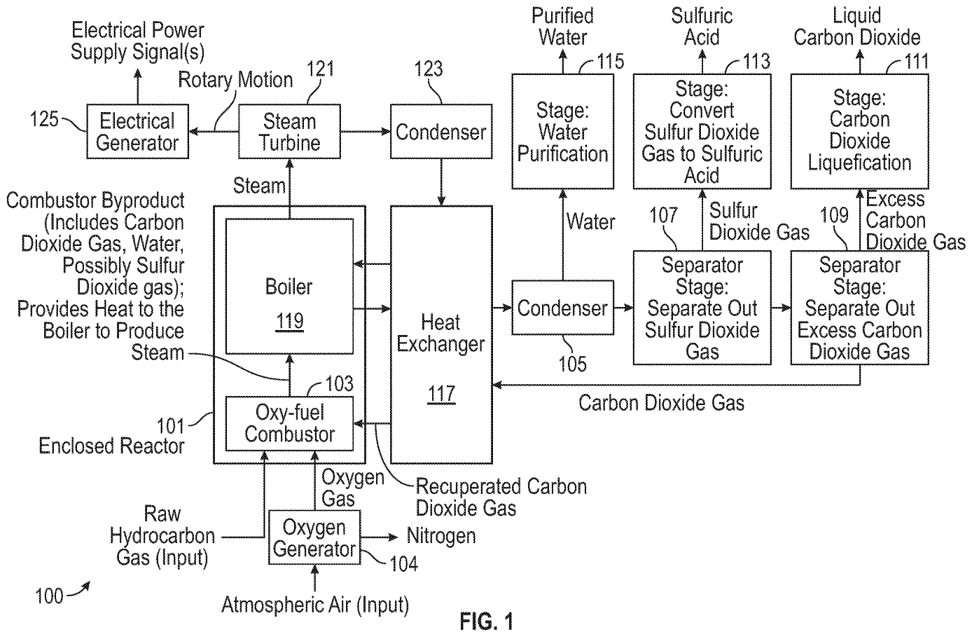

FIG. 1 is a schematic illustration of an embodiment of an oxy-fuel combustion system 100 in accordance with the present disclosure, which includes an enclosed reactor 101 with an oxy-fuel combustor 103 configured to carry out an oxy-fuel combustion process that combusts a mixture of raw (crude) hydrocarbon gas (i.e., natural gas), an oxygen-rich gas and carbon dioxide gas to produce a combustion byproduct that includes carbon dioxide, water, and possibly other byproducts. The oxygen-rich gas supplied to the oxy-fuel combustor 103 is substantially free of nitrogen. For example, in embodiments, the oxygen-rich gas supplied to the oxy-fuel combustor 103 contains less than five percent nitrogen by volume and possibly less than one percent nitrogen by volume. This configuration can substantially eliminate nitrogen from the oxy-fuel combustion process, which results in the combustion byproduct not including nitrogen oxide (NOₓ) components, which can simplify carbon dioxide capture. In embodiments, the oxy-fuel combustor 103 can be configured to operate in a flameless oxidation mode to ensure that the combustion byproduct is substantially free of nitrogen oxide (NOₓ) components and soot. In embodiments, the oxy-fuel combustor 103 can be configured to operate with zero atmospheric emissions.

The system 100 further includes an oxygen generator 104 configured to produce oxygen-rich gas from atmospheric air. The oxygen generator 104 can be configured to remove nitrogen gas from the atmospheric air and output the nitrogen preferably in liquid form as a marketable by-product. The oxygen-rich gas produced by the oxygen generator 104 is supplied as input to the oxy-fuel combustor 103 to provide the oxygen-rich gas that is substantially free of nitrogen for the oxy-fuel combustion process. In embodiments, the oxygen-rich gas produced by oxygen generator 104 is 95-99% by volume pure oxygen. In embodiments, the oxygen-rich gas produced by oxygen generator 104 can contain less than five percent nitrogen by volume and possibly less than one percent nitrogen by volume.

The system 100 further includes a combustion byproduct processing loop that is configured to perform continuous operations during the oxy-fuel combustion process. In embodiments, the combustion byproduct processing loop can include a heat exchanger 117, condenser stage 105, separator stage 107 and separator stage 109 configured to perform continuous operations during the oxy-fuel combustion process, which include receiving the combustion byproduct of the oxy-fuel combustion process, extracting carbon dioxide gas from the combustion byproduct, and recycling a portion of extracted carbon dioxide gas back into the oxy-fuel combustor 103 for use as a temperature moderator in the oxy-fuel combustion process. The heat exchanger 117 and condenser stage 105 can be configured to cool the combustion byproduct to yield a byproduct gas stream and liquid phase water. The byproduct gas stream includes carbon dioxide gas and possibly sulfur dioxide gas (which results from the oxidation of the hydrogen sulfide content of the raw hydrocarbon gas within the oxy-fuel combustor 103). The condenser stage 105 can be configured to extract the byproduct gas stream (thus separating out the liquid phase water) and route the byproduct gas stream to the separator stage 107. The separator stage 107 can be configured to separate out sulfur dioxide gas from the byproduct gas stream, thus extracting carbon dioxide gas content of the combustion byproduct for supply to the separator stage 109. The separator stage 109 can be configured to route/recycle a portion of extracted carbon dioxide gas back through the heat exchanger 117 to the oxy-fuel combustor 103 for use as a temperature moderator in the oxy-fuel combustion process. The separator stage 109 can be further configured to extract excess carbon dioxide gas (i.e., a portion of the carbon dioxide gas from the combustion byproduct that is not recycled back to the oxy-fuel combustor 103) and supply the excess carbon dioxide gas to another stage 111 that liquefies the excess carbon dioxide gas and thus avoids atmospheric release of carbon dioxide gas. In embodiments, stage 111 can produce food-grade liquid carbon dioxide suitable for use in food industries.

In embodiments, the separator stage 107 can be configured to extract sulfur dioxide gas content of the combustion byproduct and supply the extracted sulfur dioxide gas to another stage 113 that converts the sulfur dioxide gas to sulfuric acid during the oxy-fuel combustion process. This eliminates the hazardous sulfur dioxide gas component from the combustion byproduct while creating a marketable by-product of sulfuric acid. In other embodiments, stage 113 can be configured to convert the sulfur dioxide gas to solid elemental sulfur as described herein. These embodiments eliminate the hazardous sulfur dioxide gas component from the combustion byproduct while creating a marketable by-product (i.e., sulfuric acid and/or solid elemental sulfur).

In embodiments, the condenser stage 105 can be configured to extract water content of the combustion byproduct and supply the extracted water to another stage 115 that purifies the extracted water to produce purified water.

In embodiments, the heat exchanger 117 and the condenser stage 105 can be configured to capture and extract heat from the combustion byproduct and/or from the byproduct gas stream and/or from the carbon dioxide gas extracted from the combustion byproduct. The extracted heat can be used to improve overall energy efficiency and create a positive energy balance. For example, the extracted heat can be used to heat the water output by the condenser 123 for supply to the boiler 119 of the boiler-steam turbine loop described below, which can improve the efficiency of the boiler-steam turbine loop.

In embodiments, the system 100 can further include a boiler-steam turbine loop, or Rankine cycle loop (i.e., boiler 119, steam turbine 121, condenser 123) that produces rotary motion of a steam turbine (i.e., steam turbine 121) powered by the heat in the combustion byproduct produced during the oxy-fuel combustion process. The boiler-steam turbine loop is a thermodynamic cycle used in power generation where steam is produced in the boiler 119 and used to drive the turbine 121 and then condensed back into water by the condenser 123 to be recycled for supply to the boiler 119. The cycle involves converting heat energy into mechanical energy (turbine rotation) and then into electrical energy via electrical generator 125. The boiler 119 can be part of the enclosed reactor 101 and thus housed within the same module/enclosure as the oxy-fuel combustor 103. The rotary motion of the steam turbine 121 drives the electrical generator 125, which produces one or more electrical supply signals (e.g., AC power supply signals) at its output. The one or more electrical power supply signals can be distributed to one or more components of the system, which reduces external energy requirements. For example, the electrical power supply signal(s) can be distributed to the oxygen generator 104 to provide electrical energy for oxygen generation. In another example, the electrical power supply signal(s) can be distributed to stage 111 to provide electrical energy for carbon dioxide liquefaction. In yet another example, the electrical power supply signal(s) can be distributed to stage 113 to provide electrical energy for conversion of sulfur dioxide gas to sulfuric acid. In yet another example, the electrical power supply signal(s) can be distributed to stage 115 to provide electrical energy for water purification. In another example, the electrical power supply signal(s) can be distributed to one or more components of the combustion byproduct processing loop (i.e., condenser 105, separator stage 107, separator stage 109) to provide electrical energy for processing the combustion byproduct. In embodiments, the electrical energy produced by the electrical generator 125 can be sufficient to power the system's own operations with excess available for external use.

In embodiments, the system 100 can further include a control system (not shown) for managing combustion conditions and the operations performed by the components of the system 100.

The components of the system 100 (including the reactor 101 or parts thereof, the condenser 105, the separator stage 107, the separator stage 109, stage 111, stage 113, stage 115, heat exchanger 117, the parts of the boiler-steam turbine loop, and the control system) can employ a transportable, modular design that can be deployed in remote locations where permanent infrastructure is impractical, with standardized component interfaces allowing for customization and easier maintenance.

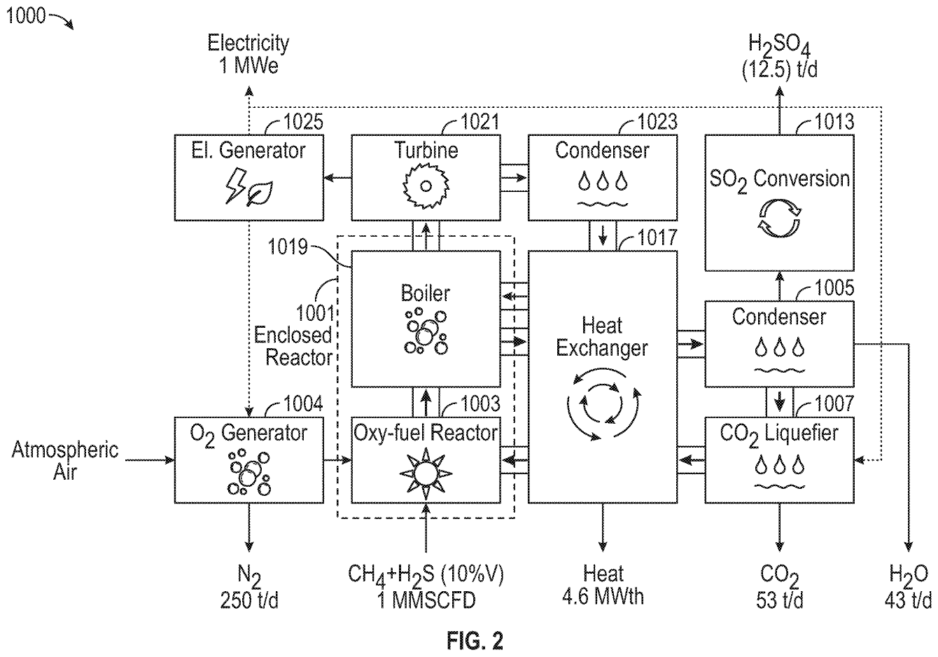

FIG. 2 is a schematic illustration of another embodiment of an oxy-fuel combustion system 1000 in accordance with the present disclosure, which includes an enclosed reactor 1001 with an oxy-fuel combustor 1003 configured to carry out an oxy-fuel combustion process that combusts a mixture of raw (crude) hydrocarbon gas (i.e., natural gas), an oxygen-rich gas and carbon dioxide gas to produce a combustion byproduct that includes carbon dioxide, water, and possibly other byproducts. The oxygen-rich gas supplied to the oxy-fuel combustor 1003 is substantially free of nitrogen. For example, in embodiments, the oxygen-rich gas supplied to the oxy-fuel combustor 1003 can contain less than five percent nitrogen by volume and possibly less than one percent nitrogen by volume. This configuration can substantially eliminate nitrogen from the oxy-fuel combustion process, which results in the combustion byproduct not including nitrogen oxide (NOₓ) components, which can simplify carbon dioxide capture. In embodiments, the oxy-fuel combustor 1003 can be configured to operate in flameless oxidation mode to ensure that the combustion byproduct is free of nitrogen oxide (NOₓ) components and soot. In embodiments, the oxy-fuel combustor 1003 can be configured to operate with zero atmospheric emissions.

In embodiments, the raw (crude) hydrocarbon gas input to the oxy-fuel combustor 1003 includes methane and optionally hydrogen sulfide gas. In embodiments, the oxy-fuel combustor 1003 can be configured to operate at temperatures between 500 °C to 4000 °C and pressures of 0.5 bar to 10 bar. In embodiments, the hydrogen sulfide gas can be no more than 10% by volume of the raw hydrocarbon gas input. In embodiments, the raw hydrocarbon gas input can be supplied as a fluid stream at any flow rate, from minimal flows to at least 1 MMSCFD, with capacity expandable through additional modular units.

In embodiments, the system 1000 can further include an oxygen generator 1004 configured to produce oxygen-rich gas from atmospheric air. The oxygen generator 1004 can be configured to remove nitrogen gas from the atmospheric air and output the nitrogen preferably in liquid form as a marketable by-product. The oxygen-rich gas produced by the oxygen generator 1004 is supplied as input to the oxy-fuel combustor 1003 to provide the oxygen-rich gas that is substantially free of nitrogen for the oxy-fuel combustion process. In embodiments, the oxygen-rich gas produced by oxygen generator 1004 is 95-99% by volume pure oxygen. In embodiments, the oxygen generator 1004 can produce up to 77 tons/day of oxygen-rich gas and up to 250 tons/day of nitrogen gas. In embodiments, the oxygen-rich gas produced by oxygen generator 1004 can contain less than five percent nitrogen by volume and possibly less than one percent nitrogen by volume.

The system 1000 further includes a combustion byproduct processing loop that is configured to perform continuous operations during the oxy-fuel combustion process. In embodiments, the combustion byproduct processing loop can include a heat exchanger 1017, condenser stage 1005, and carbon dioxide liquefaction stage 1007 configured to perform continuous operations during the oxy-fuel combustion process, which include receiving the combustion byproduct of the oxy-fuel combustion process, extracting carbon dioxide gas from the combustion byproduct, and recycling a portion of extracted carbon dioxide gas back into the oxy-fuel combustor 1003 for use as a temperature moderator in the oxy-fuel combustion process. The heat exchanger 1017 and condenser stage 1005 can be configured to cool the combustion byproduct to yield a byproduct gas stream and liquid phase water. The byproduct gas stream includes carbon dioxide gas and possibly sulfur dioxide gas (which results from the oxidation of the hydrogen sulfide content of the raw hydrocarbon gas within the oxy-fuel combustor 1003). The condenser stage 1005 can be configured to separate water and, where sulfur dioxide gas is present, sulfur dioxide gas from the byproduct gas stream—routing any separated sulfur dioxide gas to stage 1013 and routing the remaining carbon dioxide gas to the carbon dioxide liquefaction stage 1007. The carbon dioxide liquefaction stage 1007 is configured to perform two functions: recycling a portion of the extracted carbon dioxide gas back to the oxy-fuel combustor 1003 as a temperature moderator and liquefying the excess carbon dioxide gas for capture. The carbon dioxide liquefaction stage 1007 can be configured to route/recycle a portion of extracted carbon dioxide gas back through the heat exchanger 1017 to the oxy-fuel combustor 1003 for use as a temperature moderator in the oxy-fuel combustion process. The carbon dioxide liquefaction stage 1007 can be further configured to extract excess carbon dioxide gas (i.e., a portion of the carbon dioxide gas from the combustion byproduct that is not recycled back to the oxy-fuel combustor 1003) and liquefy the excess carbon dioxide gas, which avoids atmospheric release of carbon dioxide gas. In embodiments, stage 1007 can produce up to 53 tons/day of liquefied carbon dioxide. In embodiments, stage 1007 can produce food-grade liquid carbon dioxide suitable for use in food industries.

In embodiments, the condenser stage 1005 can be configured to extract sulfur dioxide gas content of the combustion byproduct and supply the extracted sulfur dioxide gas to stage 1013 that converts the sulfur dioxide gas to sulfuric acid during the oxy-fuel combustion process. In other embodiments, stage 1013 can be configured to convert the sulfur dioxide gas to solid elemental sulfur as described herein. These embodiments eliminate the hazardous sulfur dioxide gas component from the combustion byproduct, producing a marketable by-product (i.e., sulfuric acid or solid elemental sulfur). In embodiments, stage 1013 can produce up to 12.5 tons/day of sulfuric acid from the combustion byproduct (assuming 10% hydrogen sulfide content in the raw hydrocarbon gas input to the oxy-fuel combustor 1003 where it is fully oxidized to SO₂ within the oxy-fuel combustor 1003).

In embodiments, the condenser stage 1005 can be configured to extract water content of the combustion byproduct and possibly supply the extracted water to another stage (not shown) that purifies the extracted water to produce purified water. In embodiments, the condenser 1005 can extract up to 43 tons/day of water content of the combustion byproduct.

In embodiments, the heat exchanger 1017 can be configured to capture and extract heat from the combustion byproduct and/or from the byproduct gas stream and/or from the carbon dioxide gas extracted from the combustion byproduct and use of the extracted heat to improve overall energy efficiency and create a positive energy balance. For example, the extracted heat can be used to heat the water output by the condenser 1023 for supply to the boiler 1019 of the boiler-steam turbine loop described below, which can improve the efficiency of the boiler-steam turbine loop. In embodiments, the heat exchanger 1017 can extract up to 4.6 megawatts-thermal (MWth) of heat energy for use by other components of the system and/or to components of other systems.

In embodiments, the system 1000 can include a boiler-steam turbine loop, or Rankine cycle loop (i.e., boiler 1019, steam turbine 1021, condenser 1023) that produces rotary motion of a steam turbine 1021 powered by the heat in the combustion byproduct produced during the oxy-fuel combustion process. The boiler-steam turbine loop is a thermodynamic cycle used in power generation where steam is produced in the boiler 1019 and used to drive the turbine 1021 and then condensed back into water by the condenser 1023 to be recycled for supply to the boiler 1019. The cycle involves converting heat energy into mechanical energy (turbine rotation) and then into electrical energy via the electrical generator 1025. The boiler 1019 can be part of the enclosed reactor 1001 and thus housed within the same module/enclosure as the oxy-fuel combustor 1003. The rotary motion of the steam turbine 1021 drives the electrical generator 1025, which produces one or more electrical supply signals (e.g., AC power supply signals) at its output. In embodiments, the electrical power signal(s) produced by the electrical generator 1025 can be up to 1 megawatt electric power (MWe). The one or more electrical power supply signals can be distributed to one or more components of the system, which reduces external energy requirements. For example, the electrical power supply signal(s) can be distributed to the oxygen generator 1004 to provide electrical energy for oxygen generation. In another example, the electrical power supply signal(s) can be distributed to stage 1007 to provide electrical energy for carbon dioxide liquefaction. In yet another example, the electrical power supply signal(s) can be distributed to stage 1013 to provide electrical energy for conversion of sulfur dioxide gas to sulfuric acid. In another example, the electrical power supply signal(s) can be distributed to one or more components of the combustion byproduct processing loop (i.e., condenser 1005) to provide electrical energy for processing the combustion byproduct. In embodiments, the electrical energy produced by the electrical generator 1025 can be sufficient to power the system's own operations with excess available for external use.

In embodiments, the system 1000 can further include a control system (not shown) for managing combustion conditions and the operations performed by the components of the system 1000.

The components of the system 1000 (including the reactor 1001 or parts thereof, the condenser 1005, stage 1007, stage 1013, heat exchanger 1017, the parts of the boiler-steam turbine loop and the control system) can employ a transportable, modular design that can be deployed in remote locations where permanent infrastructure is impractical, with standardized component interfaces allowing for customization and easier maintenance.

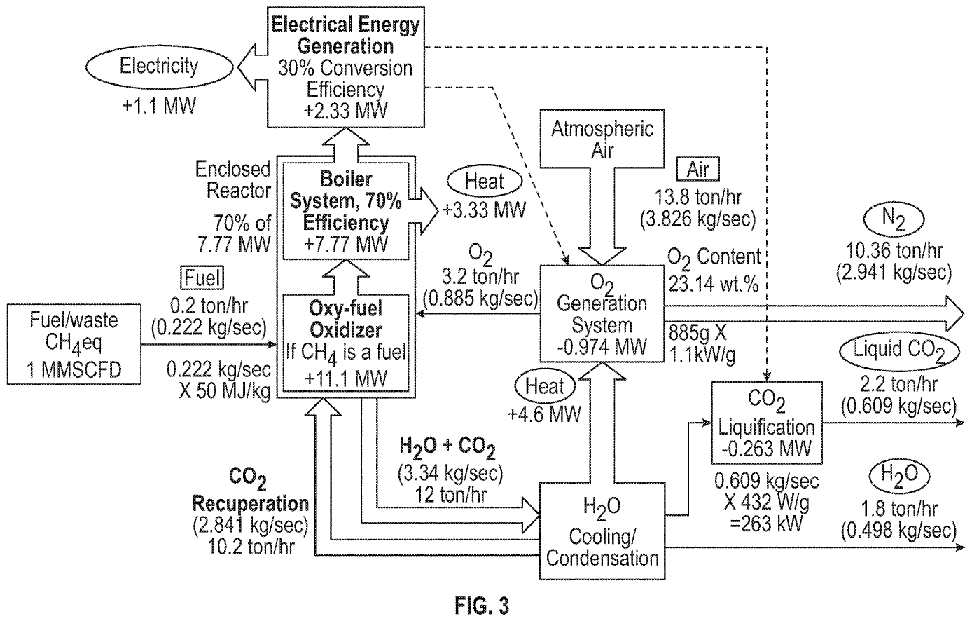

FIG. 3 is an energy balance diagram of an example embodiment of an oxy-fuel combustion system similar to the systems of FIGS. 1 and 2 as described herein. The oxy-fuel combustion system can operate with a positive energy balance, generating more energy than it consumes.

Natural gas, primarily methane (CH₄), is typically combusted with atmospheric air (~21% O₂, ~78% N₂) in industrial systems and flaring operations. This results in large flue gas volumes and harmful byproducts. The nitrogen present will not participate in combustion but dilutes the products, lowering carbon dioxide concentration to 8-12%, and complicating carbon capture operations. At high temperatures (>1300 °C), the nitrogen also forms nitrogen oxide (NOₓ) components via thermal reactions.

In the embodiments described herein, an oxy-fuel combustion process replaces air with pure oxygen, eliminating nitrogen. To control process temperature, carbon dioxide gas can be added as a diluent—typically 2-4 mol per mol CH₄—leading to the following combustion reaction in the oxy-fuel combustor (e.g., 103, 1003):

CH₄+2O₂+xCO₂→CO₂+2H₂O+xCO₂ Eqn. (1)

This approach ensures higher carbon dioxide concentration (~90% post-condensation), NOₓ-free operation, improved capture efficiency, and elimination of harmful emissions.

In cases where the natural gas input to the oxy-fuel combustion process contains significant concentrations of hydrogen sulfide (H₂S), the oxy-fuel combustion process leads to its complete oxidation, forming sulfur dioxide (SO₂) as an intermediate product in the combustion byproduct stream as follows:

2H₂S+3O₂→2SO₂+2H₂O Eqn. (2)

In embodiments, the system can capture sulfur dioxide (SO₂) in the combustion byproduct stream and convert the captured sulfur dioxide (SO₂) into sulfuric acid (H₂SO₄) (e.g., stage 113, 1013) via the contact process as follows:

2SO₂+O₂ [symbol] 2SO₃ followed by SO₃+H₂O→H₂SO₄ Eqn. (3)

This integrated approach avoids toxic emissions and enables on-site valorization of sulfur compounds. Compared to conventional gas sweetening—based on amine absorption, regeneration, and Claus sulfur recovery—the processing of the combustion byproduct stream as described herein is a simple process that eliminates solvent-related issues and achieves >98% sulfur retention without secondary tail gas treatment. Moreover, it replaces the production of elemental sulfur with marketable sulfuric acid, improving product value and reducing logistics.

Furthermore, from an economic perspective, the processing of the combustion byproduct stream as described herein can provide lower capital expenditures and lower operating expenditures for small-to-medium installations compared to conventional carbon capture systems, modular scalability, and reduced operational complexity.

In other embodiments, the system described herein can be adapted as follows:
the oxy-fuel reactor can enable sour fields development (where hydrogen sulfide is present in the input gas stream) by eliminating the discharge of hydrogen sulfide;
the system can operate without liquefaction of carbon dioxide gas extracted from the combustion byproduct of the oxy-fuel reactor;
when hydrogen sulfide is present in the input gas stream, the hydrogen sulfide is oxidized within the oxy-fuel environment to form sulfur dioxide (SO₂); the sulfur dioxide (SO₂) can be extracted and converted to sulfur gas, which can be condensed into solid form elemental sulfur; the conversion of the sulfur dioxide (SO₂) to sulfur gas can employ catalytic reduction using reducing agents like hydrogen (H₂), methane (CH₄), or carbon monoxide (CO) at high temperatures;
for non-sour fields (where hydrogen sulfide is not present in the input gas stream) with low gas rate, the system can replace flares that generate harmful emissions, and the system can provide local electricity generation, which can benefit local communities or local industrial sites.

The embodiments of the systems described herein can provide the following advantages:
utilization of an enclosed reactor: The embodiments can use an oxy-fuel combustor embodied by an enclosed reactor (furnace), which significantly reduces carbon dioxide emissions and air pollution; the oxy-fuel combustor can be designed to combust a mixture of hydrocarbon gas, oxygen and carbon dioxide, with the combustion byproduct taken away and processed to remove water by condensation and recuperate carbon dioxide back into the oxy-fuel combustor;
the system can process gas streams containing hydrogen sulfide (H₂S) with the hydrogen sulfide entering the oxy-fuel combustor together with the hydrocarbon gas where it undergoes oxidation before being directed to a specialized collection system; when hydrogen sulfide is present in the input gas stream, it is oxidized within the oxy-fuel environment to form sulfur dioxide (SO₂); the sulfur dioxide can be captured and directed to a vanadium pentoxide (V₂O₅)-based catalytic oxidation and absorption unit where it is converted into marketable sulfuric acid (H₂SO₄). Additionally, or alternatively, the sulfur dioxide (SO₂) can be captured and converted to sulfur gas, which can be condensed into solid form elemental sulfur as described herein. This approach transforms harmful contaminants into a valuable by-product;
integration of existing equipment for sulfur and nitrogen oxide abatement, as well as collection and removal of metal oxides, ash, and other oxidation products. This integration further reduces the emission of pollutants, leading to improved air quality and reduced health risks associated with pollutant emissions;
recovering and reuse of the heat generated during the oxy-fuel combustion process; this not only improves the energy balance of the system but also reduces operational costs; the heat exchanger can be connected to the boiler-steam turbine loop, or Rankine cycle loop, to heat the water produced from the condenser before supply to the boiler, further enhancing energy utilization;
use of a stream of raw (crude) hydrocarbons as the input to the oxy-fuel combustion; which avoids the use of refined or processed hydrocarbons;
generation of electricity: the system can include a boiler-steam turbine loop, or Rankine cycle loop, which generates electric energy; the electrical energy can be used for oxygen generation, carbon dioxide liquefaction, and other needs of the production system, further enhancing the efficiency and self-sufficiency of the system;
liquefaction of excess carbon dioxide: excess carbon dioxide produced by the system (which is not needed for recuperation back into the oxy-fuel combustor) can be captured from the combustion byproduct and liquefied by the existing equipment for further utilization; this not only mitigates the environmental impact of carbon dioxide emissions but also contributes to carbon capture and storage initiatives;
water purification and utilization: water can be captured from the combustion byproduct and discharged for further filtration and purification into the production system; this can ensure the water produced by and used in the system is clean and safe, reducing the risk of contamination and related issues; and
modular and transportable design: The components of the system can be constructed with standardized, interchangeable modular components that can be easily transported to remote locations or temporary installations; this modular approach enables customization based on specific operational requirements and allows for scaling by adding units to accommodate higher gas volumes.

There have been described and illustrated herein several embodiments of oxy-fuel combustion systems and methods. While particular embodiments have been described, it is not intended that the invention be limited thereto, as it is intended that the invention be as broad in scope as the art will allow and that the specification be read likewise. It will therefore be appreciated by those skilled in the art that yet other modifications could be made to the embodiments provided herein without deviating from its spirit and scope as claimed.

What is claimed is:

1. A system that employs oxy-fuel combustion to generate heat, comprising:
an oxy-fuel combustor configured to combust a mixture of raw hydrocarbon gas, an oxygen-rich gas substantially free of nitrogen and carbon dioxide gas; and
a combustion byproduct processing loop configured to continuously process a combustion byproduct of the oxy-fuel combustor to extract carbon dioxide gas from the combustion byproduct and return at least a portion of extracted carbon dioxide gas to the oxy-fuel combustor for part of the mixture combusted therein.

2. The system of claim 1, wherein:
the oxy-fuel combustor is embodied by an enclosed reactor.

3. The system of claim 1, further comprising:
an oxygen generator that produces oxygen-rich gas from atmospheric air for supply to the oxy-fuel combustor.

4. The system of claim 3, wherein:
the oxygen-rich gas produced by the oxygen generator and supplied to the oxy-fuel combustor comprises at least 95% by volume pure oxygen.

5. The system of claim 3, wherein:
the oxygen generator is further configured to produce liquid nitrogen from the atmospheric air.

6. The system of claim 1, further comprising:
a boiler and steam turbine for electricity generation, wherein the boiler employs heat of the combustion byproduct to generate steam supplied to the steam turbine.

7. The system of claim 6, wherein:
the oxy-fuel combustor and the boiler are embodied by an enclosed reactor.

8. The system of claim 1, further comprising:
a carbon dioxide liquefaction stage configured to liquefy carbon dioxide gas extracted from the combustion byproduct.

9. The system of claim 8, wherein:
the carbon dioxide liquefaction stage produces food-grade liquid carbon dioxide suitable for use in food industries.

10. The system of claim 1, wherein:
the raw hydrocarbon gas contains hydrogen sulfide that is oxidized within the oxy-fuel combustor to form sulfur dioxide gas contained within the combustion byproduct; and
the combustion byproduct processing loop is further configured to continuously process the combustion byproduct of the oxy-fuel combustor to extract sulfur dioxide gas contained within the combustion byproduct and output the extracted sulfur dioxide gas to a stage that converts the extracted sulfur dioxide gas to sulfuric acid or solid sulfur.

11. The system of claim 10, wherein:
the stage that converts the extracted sulfur dioxide gas to sulfuric acid comprises a vanadium pentoxide (V₂O₅)-based catalytic oxidation and absorption unit.

12. The system of claim 1, wherein:
components of the system have a modular architecture that allows for at least one of transportation, customization, and scaling through the addition of standardized units.

13. The system of claim 1, wherein:
the oxy-fuel combustor is configured to operate in flameless oxidation mode.

14. The system of claim 1, further comprising:
a heat exchanger configured to extract heat from the combustion byproduct and/or from the carbon dioxide gas extracted from the combustion byproduct, wherein the extracted heat is output as an alternative energy source.

15. The system of claim 1, wherein:
the system operates with a positive energy balance, generating more energy than it consumes.

16. The system of claim 1, wherein:
the oxy-fuel combustor is configured to operate at temperatures between 500 °C to 4000 °C and pressures of 0.5 bar to 10 bar; and/or
the oxy-fuel combustor is configured to process hydrocarbon gas volumes ranging from minimal flows to at least 1 MMSCFD, with capacity expandable through additional modular units.

17. An oxy-fuel combustion method, comprising:
injecting a mixture of raw hydrocarbon gas, an oxygen-rich gas substantially free of nitrogen, and carbon dioxide gas into an oxy-fuel combustor for combustion therein to produce a combustion byproduct; and
continuously processing the combustion byproduct to extract carbon dioxide gas therefrom and recycling at least a portion of the extracted carbon dioxide gas back into the oxy-fuel combustor as part of the mixture combusted therein.

18. The method of claim 17, further comprising:
using heat in the combustion byproduct to make steam in a steam-turbine system, which generates electricity powered by the steam.

19. The method of claim 17, further comprising:
extracting carbon dioxide gas from the combustion byproduct, and liquefying the extracted carbon dioxide gas; and/or
recovering water from the combustion byproduct; and/or
extracting sulfur dioxide from the combustion byproduct, and converting the sulfur dioxide to sulfuric acid or solid sulfur; and/or
extracting heat from the combustion byproduct and/or from carbon dioxide gas extracted from the combustion byproduct; and/or
processing the combustion byproduct of the oxy-fuel reactor to produce multiple outputs selected from electricity, heat, food-grade carbon dioxide, water, sulfuric acid, and solid sulfur.

20. The method of claim 19, wherein:
the oxygen-rich gas is produced by an oxygen generator that removes nitrogen from atmospheric air and outputs liquid nitrogen; and/or
the combusting operates with zero atmospheric emissions.
